(19) United States
(12) Patent Application Publication
(10) Pub. No.: US 2016/0227746 A1
(43) Pub. Date: Aug. 11, 2016

(54) Spawner System and Method

(71) Applicant: Pentair Water Pool and Spa, Inc., Cary, NC (US)

(72) Inventors: Eric C. Herbst, Orlando, FL (US); Thomas A. Croeze, Mount Dora, FL (US); William N. Mebane, Falmouth, MA (US)

(21) Appl. No.: 15/041,935

(22) Filed: Feb. 11, 2016

Related U.S. Application Data
(60) Provisional application No. 62/115,031, filed on Feb. 11, 2015.

(51) Int. Cl. A01K 61/00

(52) U.S. Cl. CPC A01K 61/00

(57) ABSTRACT

Some embodiments provide a spawner for breeding fish and other aquatic species. The spawner may include a vessel and a platform disposed therein. The platform may include a raised point, a floor that extends downwardly at an angle from the raised point to a peripheral edge, a plurality of vertical walls, and at least one cubby.

### RELATED APPLICATIONS

This application claims priority under 35 U.S.C. §119 to U.S. Provisional Patent Application No. 62/115,031 filed on Feb. 11, 2015, the entire contents of which is incorporated herein by reference.

### BACKGROUND

Scientists often rely on animal models for scientific research. Both terrestrial and aquatic animals are used as models for scientific research. One prominent aquatic animal model used by many scientists for various experiments is the zebrafish (Danio rerio, a.k.a. Brachydanio rerio). For example, zebrafish are used for modeling human disease, drug discovery, cancer research, genetics research, regenerative medicine, chemical screening, and toxicology. While zebrafish replication is considerably faster than many other animal models, current methodologies and breeding equipment used for zebrafish replication are insufficient to meet the demands of scientific research. In particular, scientists often need large numbers of developmentally synchronized zebrafish embryos within short periods of time to facilitate their research. Therefore, improved breeding equipment is needed to increase the rate and developmental uniformity of aquatic animal embryo production.

### SUMMARY

Some embodiments provide a spawner designed to hold water and at least one aquatic animal. The spawner includes a vessel and a platform disposed within the vessel. The platform includes a raised point, a floor that extends downwardly at an angle from the raised point to a peripheral edge, and a plurality of vertical walls defining at least one cubby.

Other embodiments provide a spawner having a vessel and a platform disposed within the vessel. The vessel has an internal volume shaped such that when water within the vessel is lowered from a higher holding level to a shallow spawning level during a spawning event, the cross sectional area of the vessel measured at the air-water interface is reduced to crowd fish disposed within the water into a higher animal density per unit area.

Additional embodiments provide for a method of producing a plurality of aquatic animal embryos. A vessel, an angled platform disposed within the vessel, and a valve are provided. The vessel is filled with a liquid such that the vessel is substantially full and defines a holding level of water. At least one male aquatic animal and at least one female aquatic animal are provided into the vessel. The holding level of water in the vessel is decreased. The valve is closed when the water level has reached a spawning level to facilitate a spawning event between the at least one male aquatic animal and at least one female aquatic animal.

### DESCRIPTION OF THE DRAWINGS

FIG. 1 is an exploded isometric view of a spawner according to one embodiment;

FIG. 2 is a front elevational view of the spawner of FIG. 1;

FIG. 3 is a left side elevational view of the spawner of FIG. 1;

FIG. 4 is a front, top isometric view of a spawning platform according to one embodiment;

FIG. 5 is a top plan view of the spawner of FIG. 1;

FIG. 6 is a front, left, top isometric view of a spawner suspended within a support according to one embodiment;

FIG. 7 is a top plan view of a schematic of a spawning platform according to another embodiment;

FIG. 8 is a front schematic view of the spawner of FIG. 1 illustrating first and second stages of use;

FIG. 9 is an exploded isometric view of a spawner according to another embodiment;

FIG. 10 is an isometric view of a spawning platform and a divider of the spawner of FIG. 9 according to one embodiment;

FIG. 11 is a front, left, top isometric view of the spawner with the support and plumbing apparatus of FIG. 9;

FIG. 12 is a front elevational view of the spawner with the support and plumbing apparatus of FIG. 9;

FIG. 13 is a bottom plan view of the spawner with the support and plumbing apparatus of FIG. 9; and

FIG. 14 is a left side elevational view of the spawner with the support and plumbing apparatus of FIG. 9.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which, like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The present disclosure is directed at improved breeding equipment for the production of fish embryos from various fish, including freshwater and marine fish, and may be used for breeding of many other aquatic species. For example, various types of fish may be used with the breeding equipment of this disclosure and include, for example, zebrafish (Danio rerio, a.k.a. Brachydanio rerio), rainbow trout (Oncorhynchus mykiss) and other salmonids including and brook charr (Salvelinus fontinalis), coho salmon (O. kisutch), sockeye salmon (O. nerka), and Atlantic salmon (Salmo salar). Additionally, other types of fish contemplated include the sheepshead minnow (Cyprinodon variegatus), silversides (Menidia beryllina and M. menidia), the fathead minnow (Pimephales promelas), and the Japanese medaka (Oryzias latipes). Other species include catfish such as channel catfish (Ictalurus punctatus), brown bullheads (Ameiurus nebulosus), sunfish (Mola mola), bluegill (Lepomis macrochirus), tilapia (Oreochromis mossambicus), Amazon molly (Poecilia formosa), and American eels (Anguilla rostrata). Additional species include goldfish (Carassius auratus) and koi (Cyprinus carpio). It is also envisioned that other types of aquatic species may be bred in the disclosed spawner.

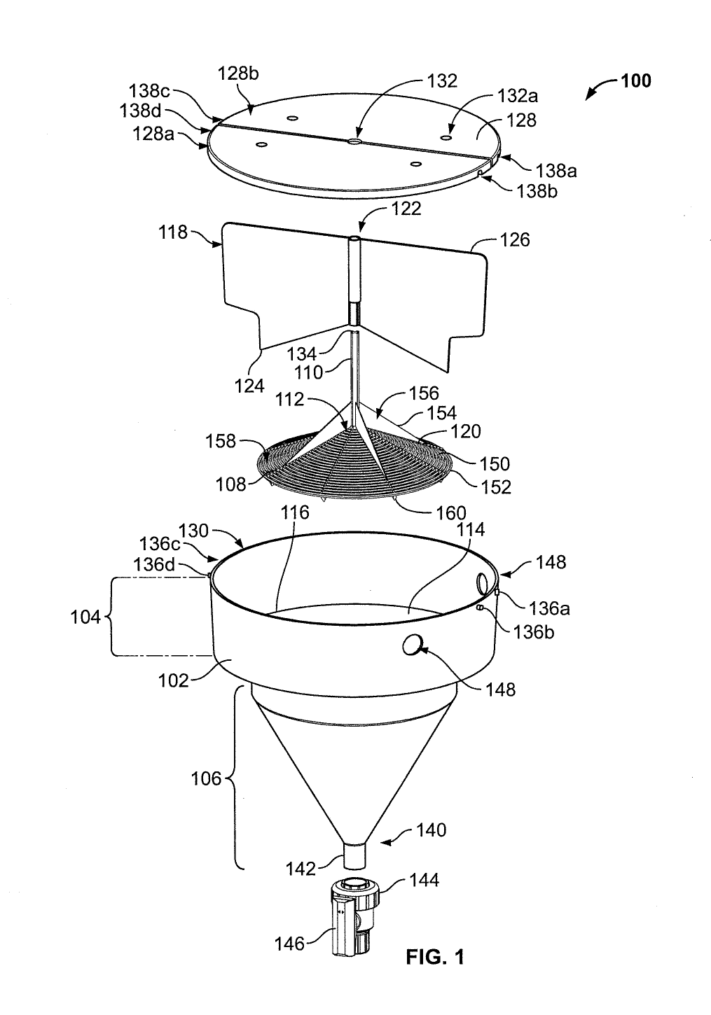

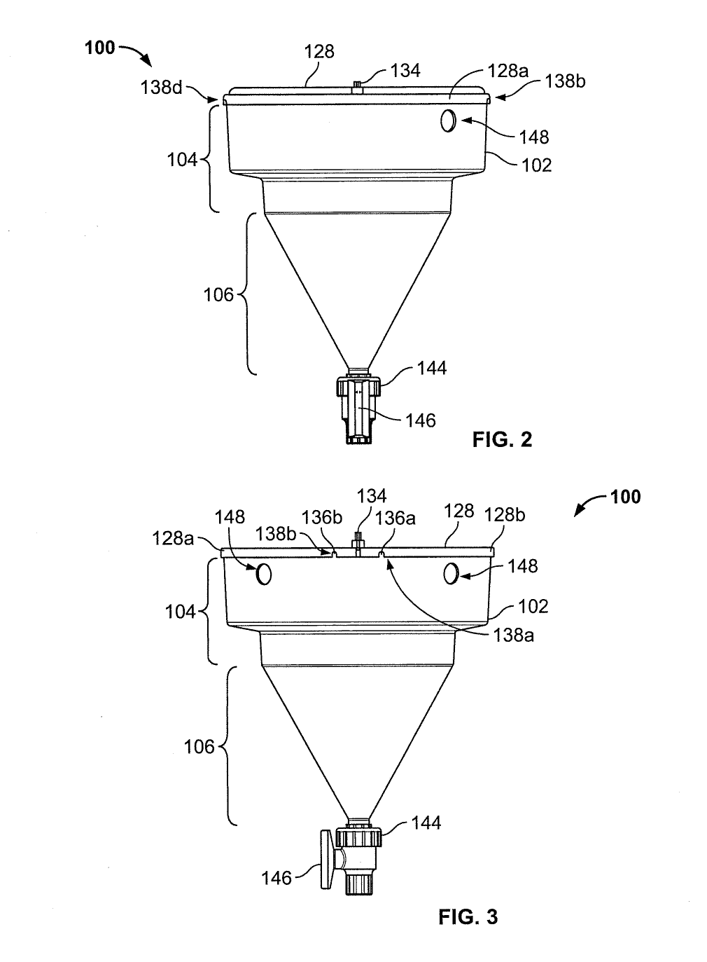

FIGS. 1-6 illustrate an envisioned spawner 100 according to one embodiment of the present disclosure. The spawner 100 includes a vessel 102, a platform 108, a divider 118, and a lid 128. The vessel 102 includes an upper chamber 104 and a lower chamber 106. The upper chamber 104 is defined by a cylindrical sidewall and the lower chamber 106 extends downwardly from the sidewall and is provided in the form of a funnel that tapers inwardly. The specific angle of the tapered sidewalls of the lower chamber 106 may be provided in such a way to efficiently collect embryos, while at the same time, interact with the platform 108 to prevent fish from entering the lower chamber 106. In one embodiment, the angle of the tapered sidewalls of the lower chamber 106 of the vessel 102 is between about 40° and about 70°. In another embodiment, the angle of the tapered sidewalls of the lower chamber 106 of the vessel 102 is between about 55° and about 65°, and more specifically, is about 60°.

A cylindrical wall defines an aperture 142 that is disposed at a lower end 140 of the vessel 102 and is adapted to provide an outlet to drain and/or fill the vessel 102. A valve 144 may be connected to the aperture 142 to permit selective drainage from the vessel 102 (or filling) upon opening of the valve 144 by turning a valve handle 146 or similar mechanism. In one embodiment, the valve 144 is provided as a ¾″ single entry socket PVC ball valve (Spears® Manufacturing Company, Sylmar, Calif.).

The vessel 102 may further include one or more ports 148 to facilitate adding, maintaining, and/or draining water at a desired level. In the illustrated example, the ports 148 are circular and extend entirely through the sidewall of the upper chamber 104 adjacent a top edge 130 of the vessel 102. When the level of liquid (e.g., water) in the vessel 102 is too high, excess water may drain through the ports 148. In some embodiments, the ports 148 may be selectively closable or omitted entirely to allow for the liquid level in the vessel 102 to extend upwardly past the ports 148 adjacent the top edge 130. In other embodiments, a valve or other mechanism may be provided in a port 148 and in communication with a water source to assist in filling the vessel 102.

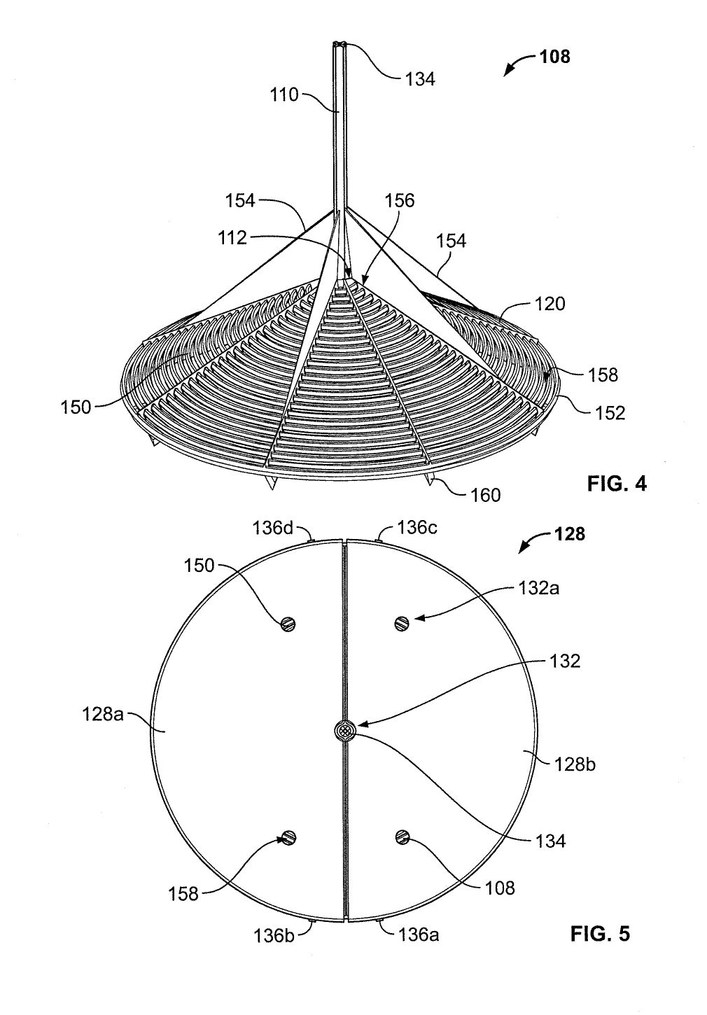

The spawner 100 also includes the platform 108, which is best shown in FIG. 4. The platform. 108 is designed to be inserted into the vessel 102 to securely rest adjacent an inner surface 114 of the vessel 102 to create a selective barrier between the upper and lower chambers 104, 106. The platform 108 has a stem 110 that extends upwardly vertically from a raised point 112 in the center of the platform 108. In some embodiments, the raised point 112 may be located off-center or at a peripheral edge 152 of the platform 108.

The platform 108 is defined by a floor 150 having a top surface 120 that surrounds and extends downwardly at an angle from the raised point 112 to the peripheral edge 152 to create a generally conical or pyramidal shape, though other shapes are contemplated, such as a wedge. The floor 150 is defined by a plurality of flanges that includes gaps 158 large enough to permit embryos, larvae or fry to pass through to the lower chamber 106, but small enough to prevent adult fish from passing through to the lower chamber 106. In this way, the floor 150 of the platform 108 is selectively permeable to fish embryos, larvae, and/or fry.

A plurality of vertical and triangular walls 154 protrude upwardly from the floor 150 of the platform 108 to the raised point 112 and connect at the stem 110 to create wedge-shaped spaces or cubbies 156 therebetween. There may be any number of walls 154, such as 2, 3, 4, 5, 6, 8, 10, or more to create any number of cubbies 156. In some embodiments, the walls 154 protrude outwardly from the stem 110 and terminate prior to reaching the peripheral edge 152 of the platform 108. In the embodiment depicted, the walls 154 protrude outwardly from the stem 110 about 75% of the distance between the stem 110 and the peripheral edge 152.

The platform 108 is designed to interact with the narrowing inner surface 114 of the vessel 102 such that the peripheral edge 152 of the platform 108 is shaped to closely fit and contact the inner surface 114 of the vessel 102. This interaction prevents adult fish from swimming into the lower chamber 106 from the upper chamber 104 (or vice versa). In this way, the spawner 100 prevents predation of fish embryos, larvae or fry by adult fish after spawning because embryos released in the upper chamber 104 pass through the platform 108 into the lower chamber 106. Other methods of suspending the platform 108 to create the upper and lower chambers 104,106 are envisioned. For example, one or more structural features 116 (see FIG. 1) may be provided on the inner surface 114, and/or the platform 108 such as, for example, an elastic and/or plastic gasket, a ledge, a bracket, a detent, threads, or other means known in the art.

The platform 108 may further include one or more supports 160 that promote structural integrity of the platform 108, for example, by making the platform 108 more rigid, and further to help securely seat the platform adjacent the inner surface 114 of the vessel 102. In the embodiment depicted, the supports 160 are elongate flanges that are provided on an underside of the floor 150 of the platform 108 and are spaced apart from each other.

Referring again to FIG. 1, the spawner 100 further includes the selectively removable divider 118, which is adapted to be inserted into the upper chamber 104 of the vessel 102 and rest on the top surface 120 of the platform 108 to divide the upper chamber 104 into two lateral volumes. The divider 118 is provided in the form of a thin sidewall that includes a central bore 122 that extends longitudinally from a bottom surface 124 to a top surface 126 of the divider 118. The stem 110 of the platform 108 is adapted to be inserted into the central bore 122 of the divider 118. Thus, when the divider 118 is placed in the upper chamber 104, the stem 110 is inserted into the central bore 122 and maintains the divider 118 in a vertical orientation.

The divider 118 is designed to enable a user to divide the upper chamber 104 into separate chambers, for example, for separation of adult fish by sex (e.g., male and female). The divider 118 is further designed for easy removal from the upper chamber 104 by simply lifting the divider 118 out of the upper chamber 104 and off the stem 110 to allow fish disposed in the upper chamber 104 on either side of the divider 118 to mix.

FIG. 5 depicts a removable lid 128 designed to enclose the vessel 102 at an upper end. The removable lid 128 includes two separate halves 128a and 128b that meet adjacent the top surface 126 of the divider 118 and that are adapted to rest on the top edge 130 of the vessel 102. The lid 128 further includes a central aperture 132 through which a distal end 134 of the stem 110 of the platform 108 passes when the lid 128 is properly seated on the vessel 102. Secondary apertures 132a may also be included in the lid 128. The lid halves 128a and 128b may be oriented and removably secured on the vessel 102 by way of detents 136a-d disposed on the vessel 102 that fit into notches 138a-d, respectively, on the lid halves 128a, 128b. In other embodiments, the lid 128 may be provided with a handle, grip, or notches that facilitate removal from and/or placement of the lid 128 on the vessel 102.

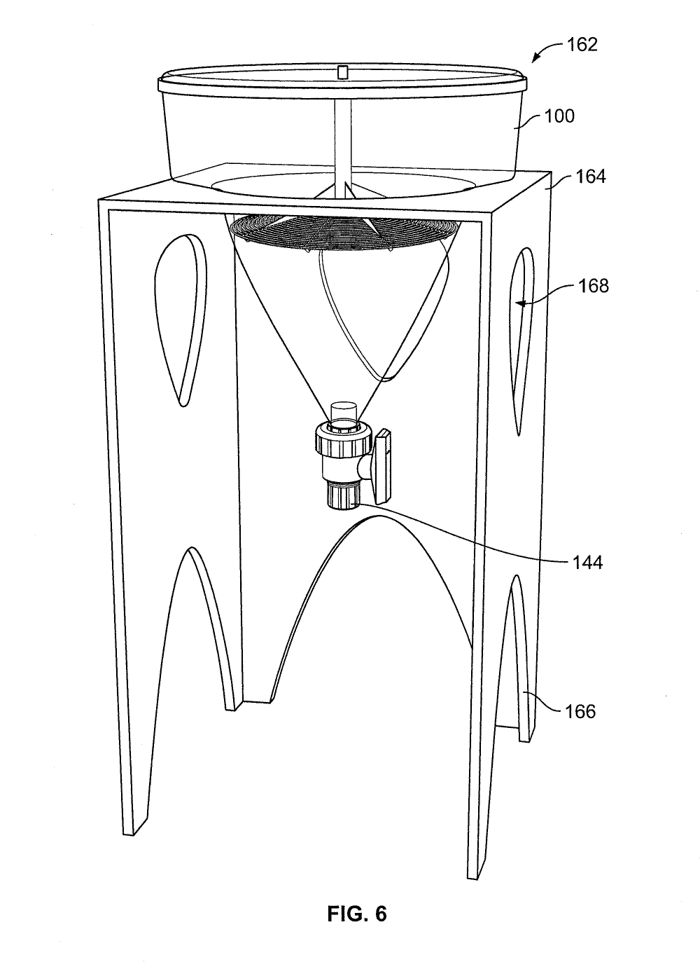

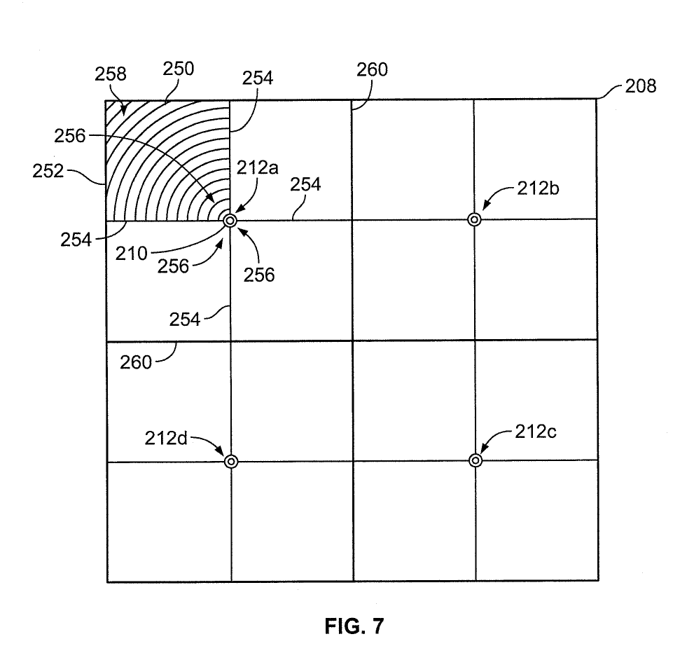

FIG. 6 illustrates one embodiment of a support 162 that is designed to hold the spawner 100 in a suspended configuration. The support 162 may include a substantially rectangular frame 164 and one or more legs 166. In some embodiments such as that depicted in FIG. 6, the support 162 may exclude one or more walls to permit viewing of the contents of the spawner 100. Additionally, the support 162 may further include one or more windows 168 to permit observation of the contents of the spawner 100. The support 162 is designed to suspend the spawner 100 in a substantially vertical position such that a gap is created between the valve 144 and a surface (not shown) in which the spawner 100 is resting. The gap allows a user of the spawner 100 to collect embryos and/or water under the valve 144 via a cup, strainer, and/or other catching mechanism.

In a further embodiment shown in FIG. 7, a platform 208 is illustrated that has four raised points or quadrants 212a-d that are identical, and of which, only one (212a) is discussed in detail for the sake of clarity. The raised point/quadrant 212a may include a stem 210 and a floor 250 (partially shown) that surrounds and extends downwardly at an angle to a peripheral edge 252 of the platform 208. One or more vertical walls 254 extend from the floor 250 of the platform 208 and to the raised point 212a where they connect to create wedge-shaped spaces or cubbies 256 therebetween. The floor 250 includes gaps 258 large enough to permit embryos to pass through, but prohibits passage of adult fish. Further, the floor 250 of each raised area/quadrant 212a-d may intersect with the floor of an adjacent raised area/quadrant to form a trough 260, which is the lowest point of the platform 208. Based on the foregoing description, it can be seen that multiplex spawning platforms 208 may be used that fit into complementary vessels (not shown) to enable users to significantly increase the number of cubbies 256 within a spawner and significantly increase the number of embryos produced at one time. Such a set-up provides an alternative to using multiple single-platform spawners, as described above.

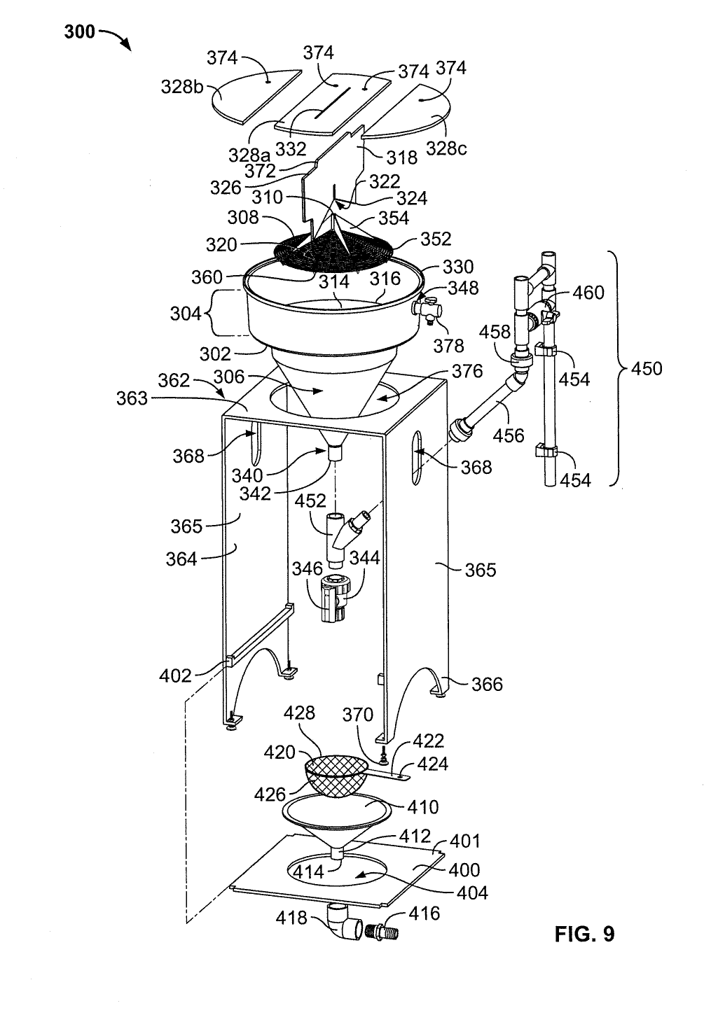

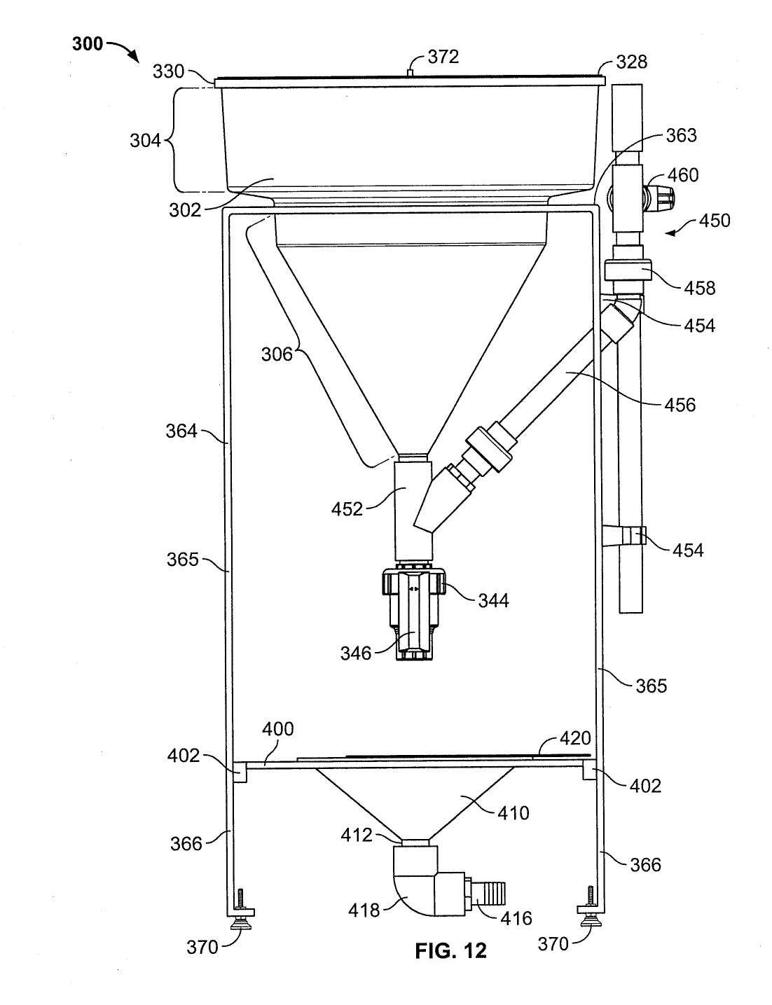

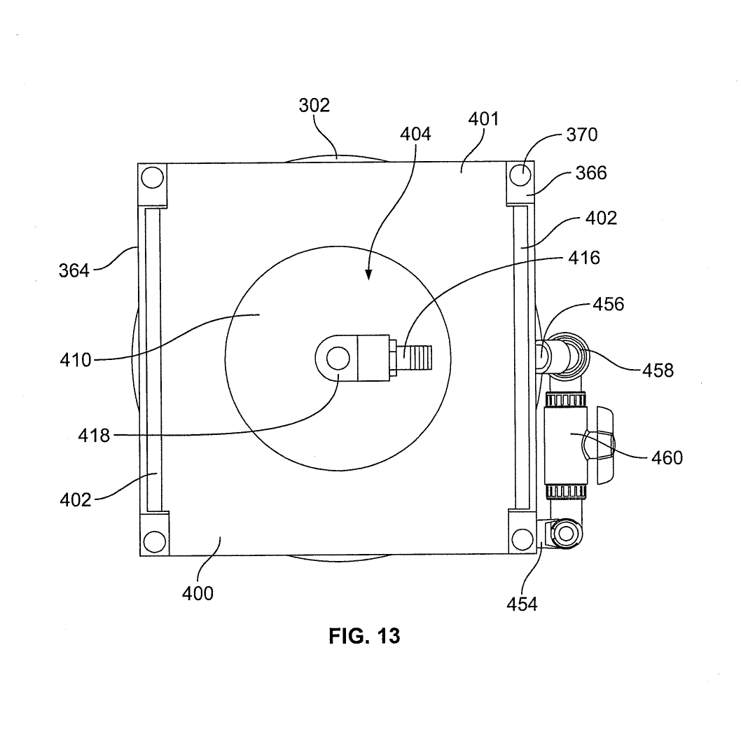

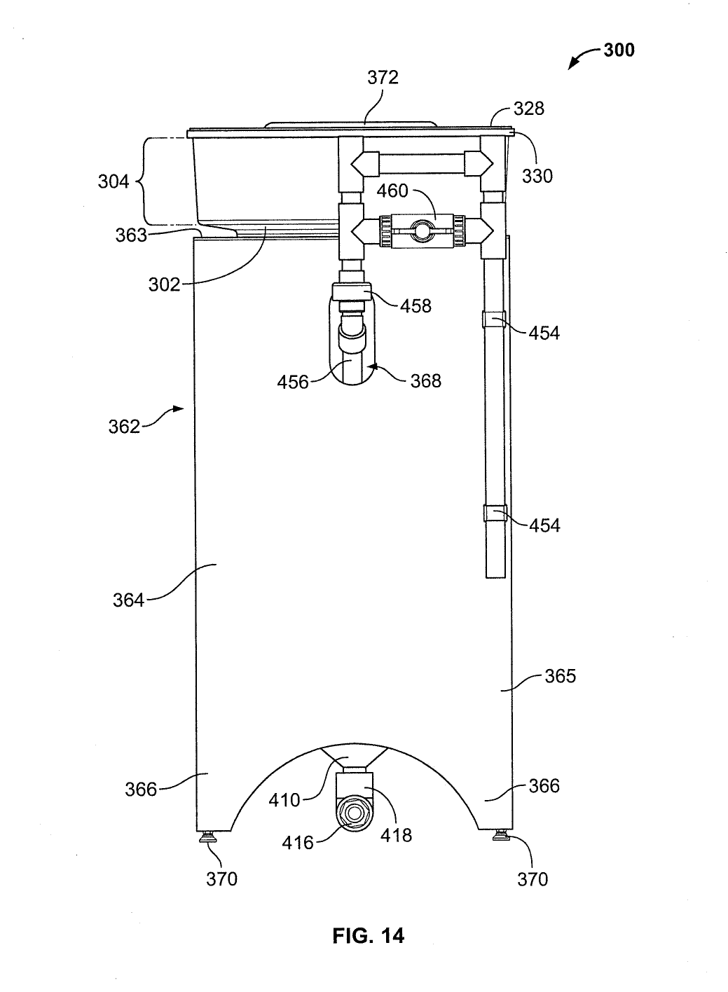

It is also envisioned that the spawner may be configured in additional ways and/or include different parts. As shown in FIGS. 9-14, an additional embodiment of a spawner 300 is depicted, whereby like elements to FIGS. 1-7 are provided with like reference numbers in FIGS. 9-14.

FIGS. 9-14 show the spawner 300 that generally includes a vessel 302, a platform 308, a divider 318, and a removable lid 328. The spawner 300 may also include one or more of a support 362, a shelf 400, a catch funnel 410, an egg strainer 420, and a plumbing apparatus 450. Each of the components may be provided separately, or sold as a kit. In one embodiment, the spawner 300 may be provided with dimensions of about 82 cm height, about 40 cm width, and about 40 cm length.

Similar to the previous embodiment, the vessel 302 includes a widened upper chamber 304 and an inwardly tapering lower chamber 306. The upper chamber 304 includes a cylindrical sidewall that defines an opening designed to receive the lid 328. The sidewall of the upper chamber 304 may include one or more ports 348 to facilitate maintaining water at a holding level. In one embodiment, a water supply valve 378 is fitted into the port 348 and is in communication with a water source that facilitates water being added to the vessel 302. It is also envisioned that the water supply valve 378 can be, or can include, a spigot, a spout, a hose connection, or the like. The water supply valve 378 may also include an elastic and/or plastic gasket (not shown), socket, threads, or may be physically soldered, welded, or epoxied into the port 348. In some embodiments, the port 348 and water supply valve 378 may be provided in a different location on the vessel 302, such as, for example, on the lower chamber 306.

The lower chamber 306 is substantially funnel shaped and tapers inwardly until terminating at a lower end 340. In one embodiment, the angle of the tapered sidewalls of the lower chamber 106 of the vessel 102 is between about 40° and about 70°. In another embodiment, the angle of the tapered sidewalls of the lower chamber 106 of the vessel 102 is between about 55° and about 65°, and more specifically, is about 60°. The lower end 340 of the vessel 302 includes a wall defining a cylindrical aperture 342 that is designed to interact with one or more components that facilitate collection of embryos and/or maintaining, filling, and/or emptying the liquid level of the spawner 300, as described in more detail below. For example, in one embodiment, the aperture 342 is configured to interact with a valve 344 having a valve handle 346 that allows for liquid and/or embryos to exit the vessel 302. In one embodiment, the valve 144 is provided as a ¾″ single entry socket PVC ball valve (Spears® Manufacturing Company, Sylmar, Calif.).

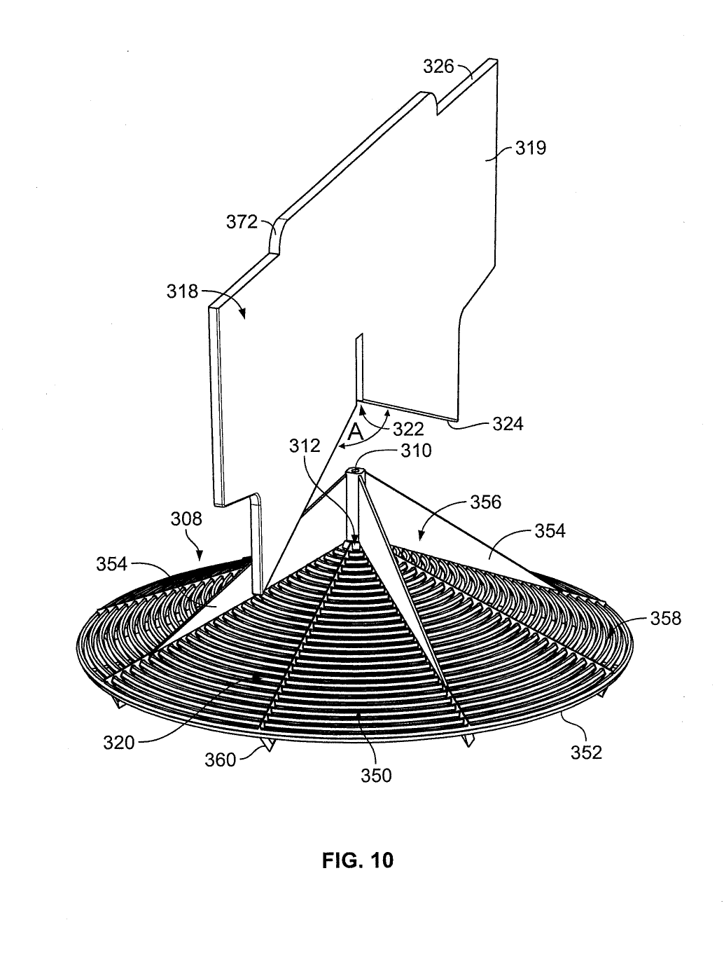

FIG. 10 depicts the platform 308 that is similar to the embodiment shown in FIG. 4. The platform 308 includes a stem 310 that extends vertically from a raised point 312 in the center of the platform 308. The stem 310 of this embodiment only protrudes upwardly a short distance as compared to the stem 110 of the previous embodiment. The stem 310 may be provided as cylindrical, square, triangular, or other shapes and may be provided with an opening or another mechanism that facilitates the interaction between the platform 308 and the divider 318, as described more below.

The platform 308 also includes a floor 350 that surrounds and extends downwardly at an angle from the raised point 312 to a peripheral edge 352. A plurality of vertical walls 354 extend from the floor 350 of the platform 308 to the raised point 312, connecting with the stem 310 to create wedge-shaped spaces or cubbies 356 therebetween. The platform may have any number of walls 354, such as 2, 3, 4, 5, 6, 8, 10, or more to create any number of cubbies 356. In one embodiment, there are four triangular vertical walls 354, spaced equidistantly on the platform 308. Similar to the embodiment shown in FIG. 4, the platform 308 includes gaps 358 in the floor 350 to permit the passage of embryos, larvae or fry into the lower chamber 306. The platform 308 may further include supports 360 that promote structural integrity of the platform 308, for example, by making the platform 308 more rigid, and to help securely seat the platform 308 adjacent to an inner surface 314 of the vessel 302.

The platform 308 may be inserted into the vessel 302 to securely rest adjacent the inner surface 314 of the vessel to create a selective barrier or boundary between the upper 304 and lower 306 chambers. In one embodiment, the inner surface 314 of the vessel 302 is about 9.5 cm wide and is tapered at an angle of about 10° to create an angled surface configured to hold the platform 308. Other methods of suspending or supporting the platform 308 to create the upper 304 and lower 306 chambers are envisioned. For example, one or more structural features 316 may be included on the inner surface 314 and/or on the platform 308 including, for example, an elastic and/or plastic gasket, a ledge, a bracket, a detent, threads or other means known in the art.

As shown in FIG. 10, the divider 318 is provided in the form of a substantially vertically oriented thin wall 319 that includes a lower edge 324 and an upper edge 326. The divider 318 also includes a central elongate notch 322 that extends upwardly from the lower edge 324 and is designed to interact with the stem 310 of the platform 308. In the embodiment depicted, the notch 322 is substantially rectangular and is shaped to provide an interference fit with the stem 310 of the platform 308. In other embodiments, the platform 308 and the divider 318 may be releasably joined in other ways as known in the art. Thus, when the divider 318 is placed in the upper chamber 304 of the vessel 302, the stem 310 is inserted into the central notch 322 and maintains the divider 218 in a substantially vertical orientation.

The divider 318 is designed to enable a user to divide the upper chamber 304 into separate chambers, for example, for separation of adult fish by sex. The lower edge 324 of the divider 318 is angled to correspond to and complement the angle of the floor 350 of the platform 308. For example, in one embodiment, the angle A of the lower edge 324 of the divider 318 is about 135°. As such, the divider 318 is shaped to be inserted into the upper chamber 304 and rest on a top surface 320 of the platform 308 to divide the upper chamber 304 into two lateral volumes. When positioned, the lower edge 324 of the divider 318 is designed to contact the top surface 320 of the platform 308 such that no fish are permitted to swim from one side of the divider 318 to the other side of the divider 318. The width of the divider 318 is designed to correspond to the width of the upper chamber 304 of the vessel 302 such that no fish are permitted to swim over or around the divider. In one embodiment, the width of the interior of the upper chamber 304 of the vessel 302 and the width of the divider 318 are substantially the same. In one specific embodiment, the width of the interior of the upper chamber 304 of the vessel 302 is about 35 cm and the width of the divider 318 is about 35 cm.

An elevated ridge 372 protrudes upwardly from the upper edge 326 of the divider 318 and is provided to interact with the removable lid 328, as discussed in more detail below. The divider 318 is designed for easy removal from the upper chamber 304 by lifting the divider 218 out of the upper chamber 304 and off the stem 310 to allow fish disposed in the upper chamber 304 on either side of the divider 318 to mix.

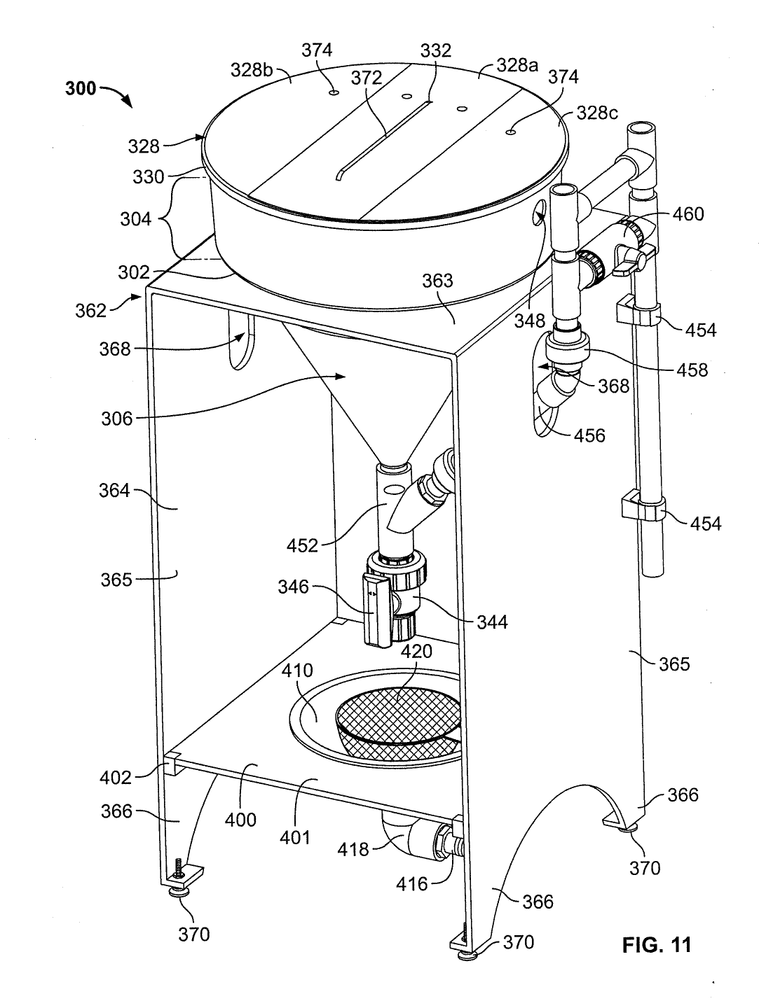

FIGS. 9 and 11 depict a removable lid 328 that is designed to at least partially enclose the vessel 302. In one embodiment, the lid 328 is substantially circular and is designed to rest on a top edge 330 of the vessel 302. The lid 328 includes a middle section 328a and two half sections 328b, 328c that are on opposing sides of the middle section 328a. The two half sections 328b, 328c may be completely independent from the middle section 328a, or one or more of the half sections 328b, 328c may be joined to the middle section 328a via a hinge (not shown) or other mechanism. A plurality of apertures 374 may be provided in one or more sections 328a, 328b, 328c of the lid 328. The apertures 374 provide fluid communication with the external environment around the spawner 300, which allow oxygen to enter the vessel 302 and carbon dioxide to exit the vessel 302. The apertures 374 are also configured to allow for distribution of feed to aquatic animals in the vessel 302 on either side of the divider 318.

The middle section 328a of the lid 328 includes a central elongate slit 332 that is shaped to accommodate the elevated ridge 372 of the divider 318. When the lid 328 is positioned on the vessel 302, portions of the lid 328 may contact the top edge 330 of the vessel 302 and the elevated ridge 372 of the divider 318 passes through and is seated within the slit 332 of the middle section 328a of the lid 328. In this way, the lid 328 may be releasably secured to the divider 318. The interface between the slit 332 of the lid 328 and the elevated ridge 372 of the divider 318 is configured to stabilize the divider 318 laterally (i.e., vertical orientation) in the vessel 302 to prevent the divider 318 from tipping or tilting. In some embodiments, the lid 328 may be removable from the divider 318 such that the lid 328 may be removed from the vessel 302 without removing the divider 318. In other embodiments, removal of the lid 328 may cause the divider 318 to also be removed from the vessel 302. The lid 328 also may be secured to the vessel 302 in any number of ways known in the art.

As shown in FIGS. 9 and 11-14, the support 362 may be provided to retain the spawner 300 in an operational position. The support 362 is defined by a substantially rectangular frame 364 that includes an upper surface 363 and two opposing vertical walls 365 that extend downwardly and terminate at one or more legs 366. The upper surface 363 of the frame 364 includes a circular opening 376 that is designed to support an exterior surface of the vessel 302 such that the spawner 300 may be releasably suspended within the opening 376. The legs 366 optionally include swivel level mounts 370 that are designed to allow the legs 366 to be adjusted to accommodate variations on the surface (not shown) in which the spawner 300 and support 362 is placed. The support 362 also includes one or more openings in the form of a passage 368 to permit observation of the contents of the spawner 300 and/or to permit attachment of the plumbing apparatus 450 to the vessel 302, as described in more detail below. In one embodiment, the support 362 alone, without the vessel 302, includes a height dimension of about 67 cm tall, a width dimension of about 35.5 cm, and a length dimension of about 35.5 cm. It is envisioned that the support may be any size to accommodate and allow for the operation of the spawner 300.

The interior surface of each of the opposing vertical walls 365 includes a shelf bracket 402 that extends across the entirety of the surface. The shelf brackets 402 are designed to support a shelf 400 that is provided in the form of a flat wall 401 with a circular opening 404. The shelf 400 is designed to be positioned below the valve 344 and/or located adjacent a bottom section of the vessel 302. In some embodiments, the shelf 400 is releasably secured to the shelf brackets 402. In other embodiments, the shelf 400 may be provided as an integral part of the support 362.

The opening 404 in the shelf 400 is designed to support the catch funnel 410, which, in turn, is designed to support the egg strainer 420. The catch funnel 410 may be conically shaped with an open top and a narrower aperture 414 at a lower end 412 (See FIG. 9). In one embodiment, the angle of the tapered sidewalls of the conical catch funnel 410 is about 100°, although other tapers and sizes are envisioned. The catch funnel 410 may be securely attached to or suspended from the shelf 400 and is situated to collect effluent from the valve 344 of the vessel 302 and/or the egg strainer 420. In one embodiment, the upper edge of the catch funnel 410 contacts the opening 404 in the shelf 400 by way of an interference fit. The aperture 414 at the lower end 412 of the catch funnel 410 may be attached to a fitting 416 and/or pipe 418 to facilitate collection of the effluent from the spawner 300. A valve (not shown) or other regulation mechanism may also be provided to assist in controlling fluid flow out of the vessel 302 and/or catch funnel 410. In some embodiments, the pipe 418 may alternatively be a hose, a tube, or other connection method.

The shelf 400 is also designed to support the egg strainer 420. The egg strainer 420 is provided in the form of a cup 426 with a handle 422 protruding outwardly from an upper edge 428 of the cup 426. In one embodiment, the handle 422 of the egg strainer 420 may have a small aperture 424 to allow the egg strainer 420 to be releasably secured to the shelf 400, such as by a screw or hook (not shown). In another embodiment, the handle 422 of the egg strainer 420 may be provided as a rigid wire frame. The egg strainer 420 may optionally have a detent or knob (not shown) opposite the handle 422 such that the egg strainer 420 can be suspended over the catch funnel 410. In some embodiments, the egg strainer 420 rests on the interior surface of the catch funnel 410. In other embodiments, the egg strainer 420 may be positioned above the catch funnel 410 and supported only by the shelf 400. In some embodiments, the egg strainer 420 is made of metal, and in one specific embodiment, the egg strainer 420 is made of stainless steel.

The cup 426 is designed to be a permeable strainer and may be made from any material, such as metal, glass, plastic, composite, and combinations thereof. The cup 426 includes a plurality of pores, holes, slits, apertures, mesh, weaving, and/or combinations thereof, which may be sized in any manner that enables retention of embryos, larvae, or fry in the cup 426 of the egg strainer 420, but is permeable to liquids or solutions. In some embodiments, the cup 426 is made of fine mesh stainless steel, and in one specific embodiment, the egg strainer 420 is a stainless steel fine mesh strainer made by Procizion.

In this configuration, the shelf 400 is situated adjacent a lower end of the support 362 and below the valve 344 such that the effluent from the valve 344 can be caught and passed through the egg strainer 420 to the catch funnel 410. At the same time, embryos, larvae, or fry are retained in the cup 426 of the egg strainer 420. When the spawning process is finished, the egg strainer 420 may be detached from the shelf 400 and/or catch funnel 410 and removed to transport the embryos, larvae, or fry into a different container.

As best seen in FIGS. 9 and 11-14, the spawner 300 may also include a plumbing apparatus 450 to facilitate removal of liquid from the vessel 302 and to control the water level in the vessel 302. In one embodiment, the plumbing apparatus 450 is provided as a double H standpipe. By selectively opening/closing a number of valves, the water level of the vessel 302 can be controlled. The plumbing apparatus 450 includes a wye pipe junction/fitting 452 that is attached at one end to the aperture 342 at the lower end 340 of the vessel 302, and at the other end is attached to the release valve 344. A pipe 456 extends from the pipe fitting 452 and protrudes upwardly toward the opening 368 provided in the frame 364 of the support 362. The pipe 456 terminates at a joint 458, which is in communication with a control valve 460. The control valve 460 may be in communication with one or more pipes. One or more of the pipes, the control valve 460, and/or the joint 458 may be secured to the support 362 via one or more pipe clamps 454. Although the plumbing apparatus 450 depicted in FIGS. 9 and 11-14 includes the pipe 456, the joints 458, and the control valve 460, it is envisioned that various other components could be added or omitted that control and adjust the water level in the vessel 302.

In use, the pipe junction 452 may be configured as to permit selective drainage from the vessel 302 upon opening the release valve 344 by turning the valve handle 346. In this way, fluid and/or embryos may be permitted to flow out of the vessel 302, through the valve 344, and to the egg strainer 420 to the catch funnel 410. Additionally, the pipe junction 452 and the plumbing apparatus 450 may be configured to remove water from the vessel 302 of the spawner 300 by opening control valve 460. In one embodiment, the upper rung of a double H standpipe configuration of the plumbing apparatus 450 dictates the water level within the vessel 302 of the spawner 300. In one embodiment, the plumbing apparatus 450 may be used in a flow through or recirculation configuration in which water continuously flows into, through and out of the water supply valve 378, vessel 302, and plumbing apparatus 450, maintaining the water in the vessel 302 at the holding level H.

To provoke a spawning event, the spawner 300 (or spawner 100) may be set up and used in the following manner. The vessel 302 of the spawner 300 may be suspended in the support 362. The plumbing apparatus 450 may be connected to the vessel 302 and the support 362 as described above. The water supply valve 378 may also be connected to a fluid (water) source. The platform 308 may be positioned within the vessel 302 and the divider 318 may be inserted through the top of the vessel 302 until contacting and/or being secured to the platform 308 via the notch 322/stem 310 interaction. The shelf 400 is inserted into the shelf brackets 402 and the catch funnel 410 is supported by the shelf via the opening 404 (or other mechanism). The egg strainer 420 is positioned within the catch funnel 410 below the valve 344 of the vessel 302.

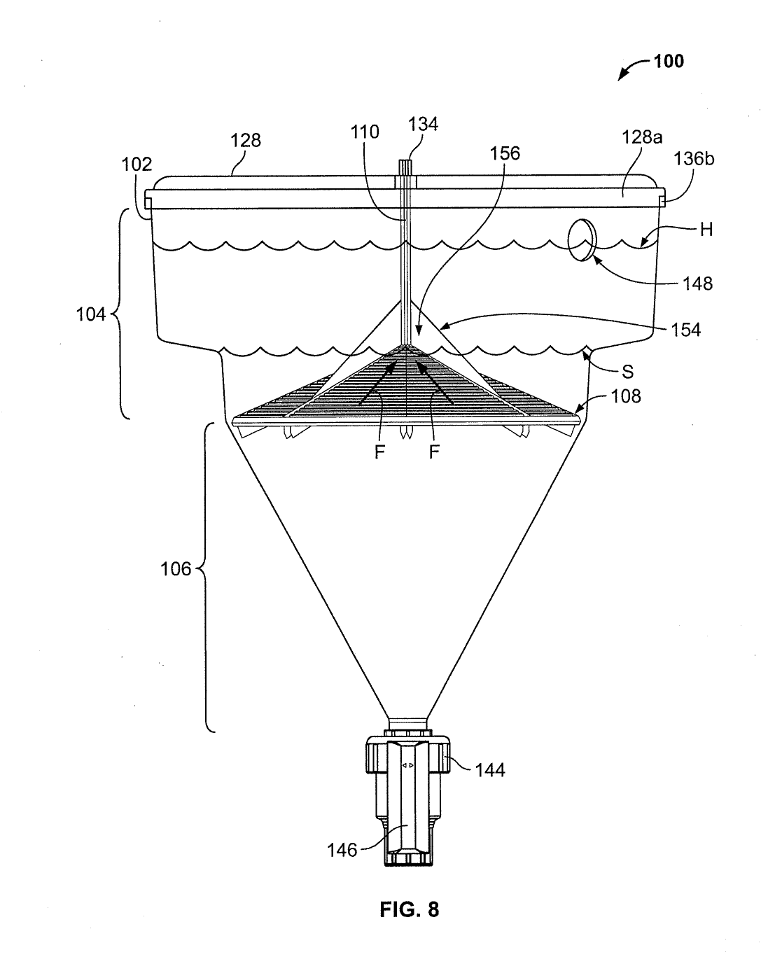

Once the spawner 300 is configured, water or another fluid may be added to the spawner 300 via the water supply valve 378 in the port 348 and/or through adding water through the top of the vessel 302 with the lid 328 removed. To add water to the vessel 302, the water source is turned on, the water supply valve 378 is configured in an open position, the release valve 344 is in a closed position, and the control valve 460 is in the closed position. In one embodiment, the water level will automatically be maintained at the holding level via the external double H standpipe configuration of the plumbing apparatus 450. Once the vessel 302 has enough fluid to be at the holding level H, as depicted in FIG. 8, one or more male aquatic species may be placed on a first side of the divider 318 and one or more female aquatic species may be placed on a second side of the divider 318, such that the male and female aquatic species are not capable of interacting.

After the male and female aquatic species are positioned within the vessel 302, the divider 318 may be removed and the water may be lowered to the spawning level S by opening the control valve 460. In one embodiment, the water level is automatically maintained at the spawning level S by the double H standpipe configuration of the plumbing apparatus 450 when the control valve 460 is in the open position. Lowering the water to the spawning level S causes the male and female aquatic species to interact in a spawning event. Due to the mating behavior of many various aquatic species, the male aquatic species chase or drive the female aquatic species into shallow water where mating may take place (arrow F). However, unless there is some obstruction hindering lateral movement of the female, the female may be able to escape to deeper water and avoid spawning. Here, the cubbies 356 serve to funnel fish into a shallower and narrower space within the walls 354 on either side, closing off any chance of lateral escape.

During the spawning event, embryos, larvae, or fry pass through the floor 350 of the platform 308 and are collected in the lower chamber 306. Once the spawning event is finished, the valve 344 may be opened via the handle 346 to allow the fluid and embryos in the lower chamber 306 to flow into the egg strainer 420. The egg strainer 420 collects the embryos and allows fluid to pass through to the catch funnel 410. Fluid flows through the catch funnel 410 and exits the system via the pipe 418.

After the spawning event, the water level may be raised again to the original holding level H, or to a new, different holding level. For example, the water level may be raised to the original holding level H by closing the control valve 460 on the double H standpipe configuration of the plumbing apparatus 450. The male and female aquatic species may be separated and/or removed from the spawner 300 and the procedure repeated.

The vessels, platforms, dividers, and/or lids may be made from a variety of materials, such as, for example, metal, glass, plastid, composites, and combinations thereof. In one embodiment, the vessels 102, 302 and the lids 128, 328 are transparent or at least translucent, and the platforms 108, 308 and the dividers 118,318 are opaque. However, any variations in light permeability and material colors are contemplated.

As discussed throughout, the spawner 100, 300 may be used to produce thousands of developmentally synchronized zebrafish embryos within a relatively short window of time, such as, from about 15 min to several hours, by taking adult fish placed in the upper chamber 104 from a deeper water, holding level (arrow H) to a spawning level (arrow S) (see FIG. 8). For example, the spawner 100, 300 may produce about 100, or about 200, or about 400, or about 600, or about 800 embryos per hour. By lowering the water level from the holding level (H) to the spawning level (S), the cross-sectional area of the vessel 102, 302 (determined by measuring the water surface area at the air-water interface) is reduced to force and/or crowd the fish or other aquatic animals into a higher density per unit area due to the shape and/or geometry of the vessel. For example, the cross-sectional area of the vessel 102, 302 may be reduced by about 20%, or by about 40%, or by about greater than 50%, and the like. The resultant shallow water environment stimulates the fish to spawn, but also, the reduction in area has the effect of breaking up dominance hierarchies that may have been previously established among a given population of animals. Further, the reduction in area prevents individual fish from establishing and or guarding a specific area/territory due to the overall higher density and crowding of the animals. While not wishing to be bound by theory, it is believed that the reduction in area allows previously subordinate fish/animals the opportunity to spawn along with the previously dominant fish/animals and thus increases the number of embryos produced per spawning event. This is due, at least in part, to rapid and random movement and mixing of all fish crowded together to more evenly disperse pheromones and other chemical signals from dominant fish that may have otherwise inhibited vessel mates from spawning in a less dense scenario where individual fish would have been able to guard and defend “optimal” spawning sites both physically and chemically.

In addition to crowding fish with respect to area, the spawner 100, 300 is unique in that the platform 108, 308 provides one or more cubbies 156, 356. Typical zebrafish mating behavior includes for the male fish to chase or drive female fish into shallow water where mating may take place (arrow F). However, unless there is some obstruction hindering lateral movement of the female, the female may be able to escape to deeper water and avoid spawning. Here, the cubbies 156, 356 serve to funnel fish into a shallower and narrower space within the walls 154, 354 on either side, closing off any chance of lateral escape. Therefore, increased incidences of successful spawning are believed to occur with the spawner 100, 300, which lead to increased numbers of embryos produced. This approach contrasts with existing technologies for the mass production of zebrafish embryos that allow fish to escape pursuit into the shallower areas during the spawning phase if they so choose by swimming laterally.

The vessel may also be of any size and may have any shape, such as rectangular, square, conical, cylindrical, triangular, and combinations thereof. In one embodiment (not shown), the vessel may be made of separate pieces that are joined together by an adhesive, a gasket, combinations thereof, and the like. The platform, divider, and the lid may be sized to the vessel in any manner that enables function of the spawner as envisioned herein.

The following examples illustrate use of the spawner 100, 300 as described above.

### Example No. 1

A spawner was set-up with a platform and a divider placed therein, with the valve closed. The spawner was filled with water to the holding water level (about 14 L). Water was recirculated at a rate of about 0.5 L/min within the spawner by means of a recirculating siphon, with outflow on one side of the divider and inflow in the opposite side. Initially, fish were placed in the upper chamber of the spawner with females on outflow side and males on incoming water side. The fish used were zebrafish from 5D Tropical, Inc. (Plant City, Fla.; “5D”) and a strain of zebrafish developed at Duke University, Durham, N.C. USA that originally came from Ekkwill Waterlife Resources (Ruskin, Fla.; “EK”). Different groups of fish were identified by source and number, such as 5D1 and 5D2, which indicate groups 1 and 2 of fish from 5D.

The spawning trial procedure was as follows: the correct numbers of fish were stocked on each side of the divider, including 24 females and 6 males (sex ratio of 4:1 females to males) in the evening of day 1; on the morning of day 2, the divider was removed and the fish comingled for 5 minutes; the flow of water was shut off; water was drained to spawning level (6 L) so that about 1 cm of the spawning platform was above the water level with the drained water collected and any embryos present set aside; the fish were allowed to spawn for 3 hours; afterwards, water flow was returned, and the vessel was filled to holding level (14 L); the flow was again turned off and water drained to the spawning level to collect the embryos; and the volume of embryos produced was measured (using an estimate of about 607 embryos/ml) and the number of embryos calculated pre-level drop and post-level drop.

Results of embryo production based on the above procedure are listed below in Table No. 1.

TABLE NO. 1
Embryo Production Results.

| | Embryos | Embryos | | |
|---|---|---|---|---|
| | Before | After | | |
| | Level | Level | | Total |
| Group | Drop | Drop | Total | Embryos |
| of Fish | (mL) | (mL) | (mL) | (calculated) |
| EK1 | 0.2 | 3.4 | 3.6 | 2185.2 |
| EK2 | 0 | 4.1 | 4.1 | 2488.7 |
| 5D1 | 0.1 | 3.1 | 3.2 | 1942.4 |
| 5D2 | 0.5 | 2.8 | 3.3 | 2003.1 |
| EK1 | 0.9 | 3.3 | 4.2 | 2549.4 |
| EK2 | 0.8 | 2.7 | 3.5 | 2124.5 |
| 5D1 | 0 | 3.2 | 3.2 | 1942.4 |
| 5D2 | 0.5 | 4 | 4.5 | 2731.5 |
| EK1 | 0.6 | 0.85 | 1.45 | 880.15 |
| EK2 | 1 | 3 | 4 | 2428 |
| 5D1 | 0 | 4.1 | 4.1 | 2488.7 |
| 5D2 | 3 | 2.95 | 5.95 | 3611.65 |

As can be seen in Table No. 1, far more embryos were produced after the water level drop in the spawner than before. These data indicate the effectiveness of the spawner design and illustrate that very large numbers of developmentally synchronized zebrafish embryos may be produced in a short period of time. For example, at least about 600 to about 800 embryos per hour may be generated per spawner of the size used.

An additional trial was performed using the same procedure as described above with a sex ratio of 2 females to 1 male and a total of 36 AB strain zebrafish, including 24 females and 12 males, all born on the same day. The total embryo production is shown in Table No. 2.

TABLE NO. 2
Embryo Production

| | Total | | |
|---|---|---|---|
| | Volume | Total | |
| | of | Number | |
| | Embryos | of | Embryos/ |
| Week | (mL) | Embryos | Female |
| 1 | 4.8 | 2913 | 121 |
| 2 | 5.4 | 3277 | 142 |
| 3 | 4.45 | 2701 | 112 |
| 4 | 5.1 | 3095 | 128 |
| 5 | 7 | 4249 | 177 |
| 6 | 5.3 | 3217 | 134 |
| 7 | 5.8 | 3520 | 146 |
| 8 | 5.9 | 3581 | 149 |
| AVE | | 3319 | |

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A spawner designed to hold water and at least one aquatic animal, comprising:
a vessel; and
a platform disposed within the vessel, the platform comprising
a raised point,
a floor that extends downwardly at an angle from the raised point to a peripheral edge, and
a plurality of vertical walls defining at least one cubby.

2. The spawner of claim 1, wherein the platform is designed to contact an interior surface of the vessel to create a boundary between an upper and lower chamber of the vessel.

3. The spawner of claim 2 further including a substantially vertically oriented divider that interacts with the platform to divide the upper chamber of the vessel into two lateral volumes.

4. The spawner of claim 3, wherein the divider is removable from the vessel.

5. The spawner of claim 3, wherein the divider is designed to separate a plurality of the aquatic animals by sex.

6. The spawner of claim 1, wherein the vessel is in communication with a release valve at a lower end and a water supply valve at an upper end.

7. The spawner of claim 1, wherein the floor of the platform is selectively permeable to aquatic animal embryos.

8. The spawner of claim 1, wherein the vessel includes a water supply valve at the top of the vessel and a release valve disposed at a lower end of the vessel, and the vessel is in further communication with a control valve via a wye pipe junction.

9. The spawner of claim 8, wherein the control valve is configured to maintain water at a holding level in the vessel.

10. A spawner, comprising:
a vessel; and
a platform disposed within the vessel,
wherein the vessel has an internal volume shaped such that when water within the vessel is lowered from a higher holding level to a shallow spawning level during a spawning event, a cross sectional area of the vessel measured at an air-water interface is reduced to crowd fish disposed within the water into a higher fish density per unit area.

11. The spawner of claim 10, wherein the higher fish density per unit area may break up dominance hierarchies among the fish and prevents individual fish from establishing or guarding a specific area territory within the vessel.

12. The spawner of claim 10, wherein the higher fish density per unit area may allow previously subordinate fish the opportunity to spawn along with previously dominant fish and increases the number of embryos produced per spawning event.

13. The spawner of claim 10, wherein the fish are confined within one or more cubbies in the platform when the water is reduced to the spawning level.

14. The spawner of claim 10, wherein the platform is sloped and includes a plurality of walls to prevent lateral movement by the fish from a first cubby to a second cubby.

15. A method of producing a plurality of aquatic animal embryos, comprising:
providing a vessel, an angled platform disposed within the vessel, and a valve;
filling the vessel with a liquid such that the vessel is substantially full and defines a holding level of water;
providing at least one male aquatic animal and at least one female aquatic animal into the vessel;
decrease the holding level of water in the vessel; and
closing the valve when the water level has reached a spawning level to facilitate a spawning event between the at least one male aquatic animal and at least one female aquatic animal.

16. The method of claim 15 further including the step of inserting a substantially vertical divider into the vessel to separate the at least one male aquatic animal and the at least one female aquatic animal.

17. The method of claim 16 further including the step of removing the divider from the vessel.

18. The method of claim 15 further including the step of providing a plumbing apparatus having at least a pipe and a control valve.

19. The method of claim 18 further including the step of opening a release valve to allow water and aquatic animal embryos to flow out of the vessel.

20. The method of claim 15 further including the step of collecting aquatic animal embryos in an egg strainer.
